(19) United States
(12) Patent Application Publication
(10) Pub. No.: US 2025/0252165 A1
(43) Pub. Date: Aug. 7, 2025

(54) SYSTEM AND METHOD FOR AUTOMATICALLY PROVIDING LOGIN INFORMATION AT GOLF SWING AREA

(71) Applicant: GOLFZON CO., LTD., Seoul (KR)

(72) Inventors: Chisoo CHUNG, Namyangju-si (KR); Jee Yeon KIM, Seoul (KR); Changhyun OH, Suwon-si (KR)

(21) Appl. No.: 19/187,493

(22) Filed: Apr. 23, 2025

Related U.S. Application Data
(63) Continuation of application No. PCT/KR2023/018224, filed on Nov. 14, 2023.

(30) Foreign Application Priority Data
Nov. 23, 2022 (KR) 10-2022-0158056

(51) Int. Cl. G06F 21/31; A63B 69/36

(52) U.S. Cl. CPC G06F 21/31; A63B 69/36

(57) ABSTRACT

Proposed herein are a golf swing area login method and system. The golf swing area login method includes performing, by a golf service server, a process for a swing area reservation and user authentication, and performing, by a golf simulation device, a swing area login process when the golf service server completes the swing area reservation and the user authentication.

### CROSS-REFERENCE TO RELATED APPLICATION

This application is a continuation application of the International Application No. PCT/KR2023/018224, filed on Nov. 14, 2023, which claims priority from Korean Patent Application No. 10-2022-0158056, filed on Nov. 23, 2022, which is also incorporated herein by reference in its entirety.

### TECHNICAL FIELD

The embodiments disclosed herein relate to a golf swing area login method and system that reserve and allocate swing areas, provide login information in golf swing areas at reservation time, and provide rewards to users who have maintained login.

### BACKGROUND ART

Recently, the popularity of screen golf ranges has been increasing. As screen golf ranges, which are cheaper to use than actual golf courses and can be enjoyed without restrictions on time, location, and the like, have been opened within golfers' living areas, anyone can easily enjoy golf simulation games.

Screen golf provides a golfer with a virtual golf course image, and, when the golfer hits a golf ball with a golf club through a golf swing, just like playing on an actual golf field, senses the speed and direction of the golf ball or golf club and outputs a situation in which the ball moves on a virtual golf course as an image.

Golfers need to visit shops in person or make reservations by phone in order to make reservations for swing areas of screen golf ranges. It is not easy to synchronize information based on shops' swing area operation policies and users' application access, so that it is not easy to make online reservations. Since reservations are mainly made offline, it is difficult to make reservations when shops are crowded due to a specific weather environment, a specific day of the week, or a specific time zone, and there is the inconvenience of having to wait in line at the shops.

In the case of reservations at shops or reservations by phone, there are no separate notification services, so that it is not easy to check reservation time or the locations of swing areas and reservations are often confused or forgotten by mistake.

When the reservation time arrives in a screen golf range, there is the inconvenience of having to directly enter login information in a swing area, so that many users who are impatient or unfamiliar with kiosks are using courses as non-members.

Meanwhile, the above-described background technology corresponds to technical information that has been possessed by the present inventor in order to contrive the present invention or that has been acquired in the process of contriving the present invention, and can not necessarily be regarded as known technology that had been known to the public prior to the filing of the present invention.

For reference, patent document 1 discloses an invention regarding a golf practice range reservation system, and patent document 2 discloses an invention regarding a golf practice range usage service system. Patent documents 1 and 2 merely disclose general content regarding reservations for a golf practice range, and do not provide technology for automating golf swing area login according to reservations.
(Patent Document 1) Korean Patent No. 10-1960758 (published on Mar. 15, 2019)
(Patent Document 2) Korean Patent Application Publication No. 10-2018-0036092 (published on Apr. 9, 2018)

### DISCLOSURE

### Technical Problem

An object of the embodiments disclosed herein is to propose a golf swing area login method and system that enable online golf swing area allocation reservations, may increase the swing area login rate of golf simulation users by providing an automated login method for swing area reservation time, and may provide personalized missions and rewards by collecting swing data of golf simulation users who are logging in to swing areas.

Other objects and advantages of the present invention may be understood from the following description, and will be more clearly understood from embodiments. Furthermore, it will be readily understood that the objects and advantages of the present invention may be implemented by the means and combinations thereof set forth in the attached claims.

### Technical Solution

As a technical means for overcoming the above-described technical problem, a golf swing area login method includes: performing, by a golf service server, a process for a swing area reservation and user authentication; and performing, by a golf simulation device, a swing area login process when the golf service server completes the swing area reservation and the user authentication.

According to another embodiment, a golf service server includes: a communication interface configured to receive a swing area allocation request from a user terminal or an administrator terminal, to transmit a swing area allocation response to the user terminal or the administrator terminal, to transmit a swing area login request to a golf simulation device, to receive a swing area login response from the golf simulation device, and to transmit a swing area login completion notification to the user terminal or the administrator terminal; and a controller configured to control the communication interface to transmit the swing area login completion notification after receiving the swing area login response from the golf simulation device; wherein the swing area login completion notification is information indicating that the state of a login has been automatically output according to a login initiation condition set in advance in the golf simulation device.

According to still another embodiment, a golf simulation device includes: a communication interface configured to receive a swing area login request from a golf service server, and to transmit a swing area login response to the golf simulation device; an output interface configured to output the state of a login as visual information, auditory information, tactile information, or a combination thereof; and a controller configured to determine the time point at which the state of the login is output after receiving the swing area login request from the golf service server; wherein the swing area login response is information indicating that the state of the login has been automatically output according to a login initiation condition set in advance in the golf simulation device.

According to still another embodiment, an administrator terminal includes: a communication interface configured to transmit a swing area allocation request to a golf service server, to receive a swing area allocation response from the golf service server, and to receive a swing area login completion notification from the golf service server; and an output interface configured to output the swing area login completion notification as visual information, auditory information, tactile information, or a combination thereof; wherein the swing area login completion notification is information indicating that the state of a login has been automatically output according to a login initiation condition set in advance in a golf simulation device that communicates with the golf service server.

According to still another embodiment, a user terminal includes: a communication interface configured to transmit a swing area allocation request to a golf service server, to receive a swing area allocation response from the golf service server, and to receive a swing area login completion notification from the golf service server; and an output interface configured to output the swing area login completion notification as visual information, auditory information, tactile information, or a combination thereof; wherein the swing area login completion notification is information indicating that the state of a login has been automatically output according to a login initiation condition set in advance in a golf simulation device that communicates with the golf service server.

### Advantageous Effects

According to any one of the above-described technical solutions, there may be proposed the golf swing area login method and system that provide the convenience of reservation by enabling swing area reservations to be made online.

In addition, according to any one of the above-described technical solutions, there may be proposed the golf swing area login method and system that increase the swing area login rate of golf simulation users by providing an automated login method for the swing area reservation time.

In addition, according to any one of the above-described technical solutions, there may be proposed the golf swing area login method and system that collect big data required for personalized services by collecting swing data of golf simulation users who are logging in to swing areas.

In addition, according to any one of the above-described technical solutions, there may be proposed the golf swing area login method and system that provide personalized missions and rewards to golf simulation users who are logging in to swing areas through the analysis of big data.

The effects that may be obtained by the embodiments disclosed herein are not limited to the above-described effects, and other effects that have not been described above will be clearly understood by those having ordinary skill in the art, to which the disclosed embodiments pertain, from the following description.

### DESCRIPTION OF DRAWINGS

The accompanying drawings below illustrate preferred embodiments disclosed herein and serve to help a reader further understand the technical spirit disclosed herein together with specific details for the practice of the invention, so that the content disclosed herein should not be interpreted as being limited to the items illustrated in the drawings:

FIG. 1 is a diagram showing a screen golf system for implementing a golf simulation device according to one embodiment;

FIG. 2 is a diagram illustrating a swing area login system including a golf simulation device according to one embodiment;

FIGS. 3 and 4 are flowcharts illustrating a golf swing area login method according to one embodiment;

FIGS. 5 to 8 are flowcharts illustrating swing area allocation attempted using an administrator terminal in a golf swing area login method according to one embodiment;

FIGS. 9 and 10 are flowcharts illustrating a swing area reservation attempted using a user terminal in a golf swing area login method according to one embodiment;

FIG. 11 is a flowchart illustrating automatic login using a golf simulation device in a golf swing area login method according to one embodiment;

FIG. 12 is a view illustrating a swing area change situation in a golf swing area login method according to one embodiment; and

FIG. 13 is a flowchart illustrating the provision of a mission and a reward after login in a golf swing area login method according to one embodiment.

### MODE FOR INVENTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is ‘directly connected’ to the other component but also a case where the one component is ‘connected to the other component with a third component arranged therebetween.’ Furthermore, when one portion is described as “including” one component, this does not mean that the portion does not exclude another component but means that the portion may further include another component, unless explicitly described to the contrary.

Embodiments will be described in detail below with reference to the accompanying drawings.

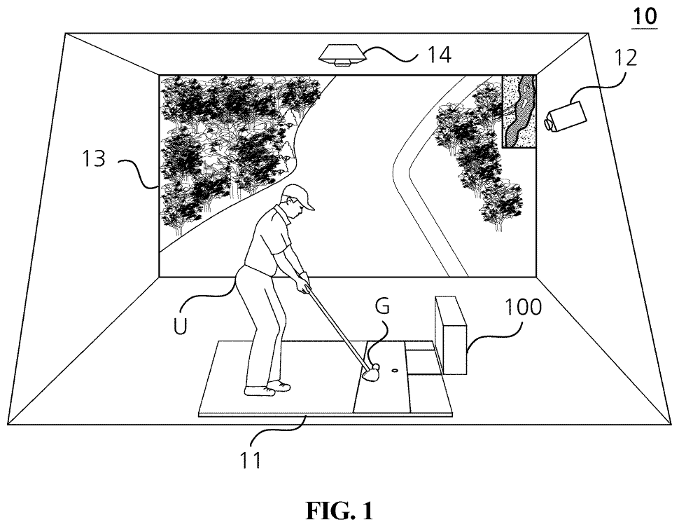

FIG. 1 is a diagram showing a screen golf system for implementing a golf simulation device according to one embodiment.

As shown in FIG. 1, a screen golf system 10 according to one embodiment described herein includes a swing mat 11 configured such that a golfer U can hit a golf ball G thereon, a sensing device 12 configured to sense at least one of the movements of the golfer U, the golf ball G, and a golf club, an image output device 14 configured to output predetermined images onto a screen 13, and a golf simulation device 100 configured such that data required for golf simulation is stored and processed therein. In this case, as shown in FIG. 1, the screen 13 may be provided in front of the swing mat 11, but is not limited thereto, and may be provided in various manners, such as being provided on a portion of the floor between the swing mat 11 and the front.

The virtual golf simulation device 100 according to one embodiment described therein is provided to store data required for virtual golf simulation and to process images related to virtual golf simulation, such as an image of a virtual golf course and an image of the movement of a golf ball. In addition, images processed by the virtual golf simulation device 100 are displayed on the screen 13.

When the golfer U hits the golf ball G toward the screen 13 on the swing mat 11, the sensing device 12 may sense it and transfer it to the golf simulation device 100, and the virtual golf simulation device 100 may simulate a virtual ball trajectory on a virtual golf course based on at least one of the movements of the golfer U, the golf ball G, and the golf club. In other words, the golf simulation device 100 may construct golf simulation image information, such as an image of the movement of a ball on a virtual golf course, by considering the characteristics of the movement of an actual golf ball, and may project the golf simulation image information onto the screen 13 via the image output device 14 implemented as a projector or the like, thereby allowing a golf game to be played through simulation.

The golf simulation device 100 operates to process complicated manipulations for virtual golf simulation. For example, the golf simulation device 100 may allow a golfer to log in for virtual golf simulation or to manipulate a simulation environment in response to the acquisition of a manipulation command.

The screen golf system 10 may further include a ‘swing image camera (not shown)’ configured to capture a golfer's swing motion when detecting the movement of a golf ball or golf club attributable to the golfer's swing motion. The swing image camera is installed at a location where the golfer's swing motion can be captured. For example, the swing image camera may be installed near the swing mat (a front, rear, side, or diagonal location, or like). The swing image camera may communicate with the golf simulation device 100. In this case, the golf simulation device 100 may receive image data obtained by capturing the golfer's swing motion and store it as a ‘swing image.’

The sensing device 12 is a device that acquires an image of a situation in which the golf ball G is hit by the golf club in a hitting area while monitoring the hitting area, i.e., a predetermined area where the golf ball G is placed and hit by the golf club in the swing mat 10, and senses at least one of the movements of the golfer U, the golf ball G, and the golf club from the image.

The sensing device 12 may be provided as an imaging device such as a vision sensor that captures an image of the hitting area with a camera. In connection with this, although the sensing device 12 is shown as being installed on a wall of the screen golf system in FIG. 1, the sensing device 12 may be implemented as a sensor installed on the ceiling of the screen golf system and a sensor installed on a side wall of the screen golf system. Alternatively, the sensing device 12 may be implemented in the golf simulation device 100. For example, when the sensing device 12 is implemented as two vision sensors, the two vision sensors may monitor the hitting area in an overlapping manner. This is an example, but the sensing device 12 is not necessarily limited to this and includes cases in which two or more vision sensors are installed. The location where the vision sensor is installed may include all cases where the vision sensor is installed anywhere in the booth of the screen golf system as well as the ceiling or wall. Itis obvious that the sensing device 12 may be provided as an IR sensor, a radar sensor, or the like.

As the sensing device 12 senses the movement of at least one of the golfer, the golf ball and the golf club, the sensing device 12 calculates sensing information such as movement parameters for the movement of the golf ball, and transfers the sensing information to the golf simulation device 100. The golf simulation device 100 may calculate shot data from the sensing information.

Although the golf simulation device 100 has been described as being applied to the screen golf system 10 in detail, the application thereof is not necessarily limited to the screen golf system 10, but it may be applied to all types of systems or apparatuses in which a virtual golf course is simulated and imaged and an image of the movement of a virtual ball is simulated.

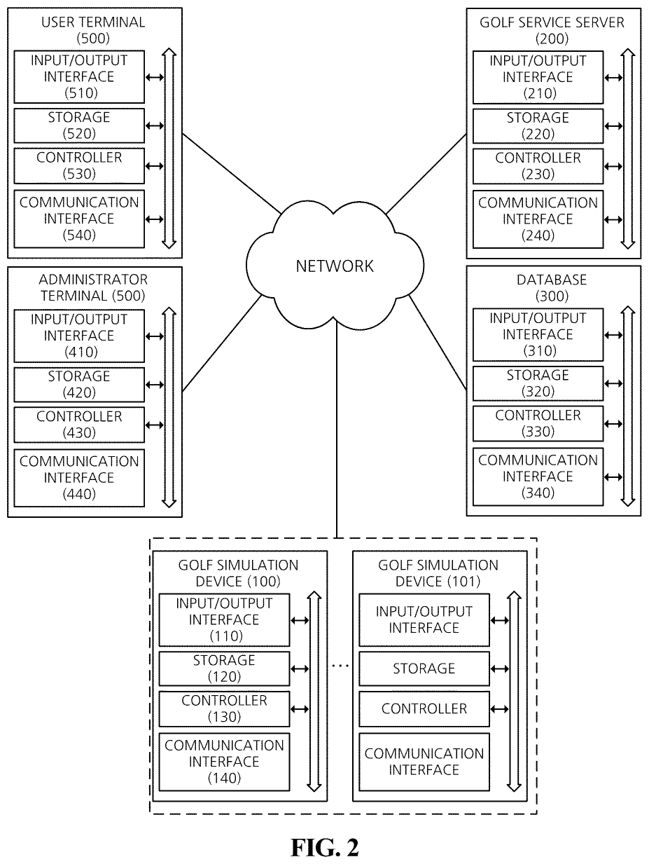

FIG. 2 is a diagram illustrating a swing area login system including a golf simulation device according to one embodiment.

As shown in FIG. 2, the golf swing area login system may be implemented as a server-client system in which a golf simulation device 100, a golf service server 200, a database 300, an administrator terminal 400, a user terminal 500, and a combination thereof are connected to each other over a network and communicate with each other. For example, the golf swing area login system may include the golf simulation device 100 and the golf service server 200.

The golf service server 200 and the golf simulation device 100 may be implemented as a single server-client system by cooperating with each other, the golf service server 200, the administrator terminal 400, and the user terminal 500 may be implemented as a single server-client system by cooperating with one another, and the golf simulation device 100, the administrator terminal 400, and the user terminal 500 may be implemented as a single server-client system by cooperating with one another.

The golf simulation device 100 and the golf service server 200 interact with a user account via the user terminal 500 and interact with an administrator account via the administrator terminal 400, thereby allowing a screen golf user and a screen golf administrator to receive virtual golf content services provided by the golf simulation device 100 and the golf service server 200.

The administrator terminal 400 and the user terminal 500 may each be implemented as a computer, a portable terminal, a television, a wearable device, or the like that can access a remote server over a network or connect to another terminal and a server. In this case, the computer includes, e.g., a notebook, a desktop, a laptop, and the like each equipped with a web browser. The mobile terminal is, e.g., a wireless communication device capable of guaranteeing portability and mobility, and may include all types of handheld wireless communication devices, such as a Personal Communication System (PCS) terminal, a Personal Digital Cellular (PDC) terminal, a Personal Handyphone System (PHS) terminal, a Personal Digital Assistant (PDA), a Global System for Mobile communications (GSM) terminal, an International Mobile Telecommunication (IMT)-2000 terminal, a Code Division Multiple Access (CDMA)-2000 terminal, a W-Code Division Multiple Access (W-CDMA) terminal, a Wireless Broadband (Wibro) Internet terminal, a smartphone, a Mobile Worldwide Interoperability for Microwave Access (mobile WiMAX) terminal, and the like. Furthermore, the television may include an Internet Protocol Television (IPTV), an Internet Television (Internet TV), a terrestrial TV, a cable TV, and the like. Moreover, the wearable device is an information processing device of a type that can be directly worn on a human body, such as a watch, glasses, an accessory, clothing, shoes, or the like, and can access a remote server or be connected to another terminal directly or via another information processing device over a network.

The golf simulation device 100 and the administrator terminal 400 may each be installed in the form of a kiosk in a shop where the screen golf system 10 is operated.

The golf simulation device 100 and the golf service server 200 may each be implemented as a computer capable of communicating with the user terminal 500 having an application for interaction with a user or a web browser installed thereon and the administrator terminal 400 having an application for interaction with an administrator or a web browser installed thereon over a network, or may be implemented as a cloud computing server. The golf simulation device 100 and the golf service server 200 may each include a storage device capable of storing data, or may store data via the database 300.

More specifically, each of the golf simulation device 100, the golf service server 200, the database 300, the administrator terminal 400, and the user terminal 500 may include an input/output interface 110, 210, 310, 410, or 510, storage 120, 220, 320, 420, or 520, a controller 130, 230, 330, 340, or 350, and a communication interface 140, 240, 340, 440, or 540, as shown in FIG. 2.

The input/output interfaces 110, 210, 310, 410, and 510 may each be configured as an input/output means for receiving information and outputting the results of processing. The input/output interfaces 110, 210, 310, 410, and 510 may each include an input interface for receiving input and an output interface for displaying information such as the performance results of a task or a state. For example, the input/output interfaces 110, 210, 310, 410, and 510 may each include an operation panel for receiving operator input and a display panel for displaying screens.

The input interfaces may each include devices capable of receiving various types of operator input, such as a keyboard, physical buttons, a touch screen, a camera, and a microphone. The output interfaces may each include a display panel, a speaker, and a vibration device. The input/output interfaces 110, 210, 310, 410, and 510 are not limited thereto, but may include components that support various types of input/output.

The input/output interfaces 110, 210, 310, 410, and 510 may each receive information separately from the communication interface 140, 240, 340, 440, or 540, and may each extract and acquire some of the necessary information from previously input and stored items.

Various types of data, such as a file or a program, may be installed and stored in the storage 120, 220, 320, 420, and 520. The controllers 130, 230, 330, 430, and 530 may each access and use data stored in the storage 120, 220, 320, 420, or 520, or may each store new data in the storage 120, 220, 320, 420, or 520. Furthermore, the controllers 130, 230, 330, 430, and 530 may each execute a program installed in the storage 120, 220, 320, 420, or 520.

The storage 120, 220, 320, 420, and 520 may each store information required for login and a login state. The storage 120, 220, 320, 420, and 520 may store an algorithm used for login. The algorithm may be defined based on predetermined rules, and may include a specific function or a machine learning model such as an artificial neural network.

The controllers 130, 230, 330, 430, and 530 may each control the overall operation of each device 100, 200, 300, 400, or 500, and may each include a processor such as a CPU, a GPU, or the like. The controllers 130, 230, 330, 430, and 530 may each execute a program stored in the storage 120, 220, 320, 420, or 520, or may each compute data by using an algorithm or artificial intelligence model stored in the storage unit 120, 220, 320, 420, or 520. Furthermore, the controllers 130, 230, 330, 430, and 530 may each store processed data back in the storage 120, 220, 320, 420, or 520.

The communication interfaces 140, 240, 340, 440, and 540 may each be connected to the communication interface of another device and transmit and receive information. The communication interfaces 140, 240, 340, 440, and 540 may each perform wired/wireless communication with another device or a network. To this end, the communication interfaces 140, 240, 340, 440, and 540 may each include a communication module that supports at least one of various wired/wireless communication methods. For example, the communication module may be implemented in the form of a chipset.

The wireless communication supported by each of the communication interfaces 140, 240, 340, 440, and 540 may be, for example, generational mobile communication, Wireless Fidelity (Wi-Fi), Wi-Fi Direct, Bluetooth, Ultra Wide Band (UWB), Near Field Communication (NFC), or the like. Furthermore, the wired communication supported by each of the communication interfaces 140, 240, 340, 440, and 540 may be, for example, a LAN cable, USB, High Definition Multimedia Interface (HDMI), or the like.

The overall operation of the controller 130 of the golf simulation device 100 may be implemented in the golf simulation device 100, or some of the operation of the controller 130 of the golf simulation device 100 may be implemented in the golf simulation device 100 and the rest thereof may be implemented in the controller 230 of the golf service server 200 that communicates with the golf simulation device 100.

The communication interface 440 of the administrator terminal 400 may transmit a swing area allocation request to the golf service server 200, may receive a swing area allocation response from the golf service server 200, and may receive a swing area login completion notification from the golf service server 200.

The output interface of the administrator terminal 400 may output the swing area login completion notification as visual information, auditory information, tactile information, or a combination thereof.

The swing area login completion notification output by the output interface of the administrator terminal 400 may be information indicating that a login state has been automatically output according to the login initiation condition set in advance in the golf simulation device 100 that communicates with the golf service server 200.

The communication interface 540 of the user terminal 500 may transmit a swing area allocation request to the golf service server 200, may receive a swing area allocation response from the golf service server 200, and may receive a swing area login completion notification from the golf service server 200.

The output interface of the user terminal 500 may output the swing area login completion notification as visual information, auditory information, tactile information, or a combination thereof.

The swing area login completion notification output by the output interface of the user terminal 500 may be information indicating that a login state has been automatically output according to the login initiation condition set in advanced in the golf simulation device 100 that communicates with the golf service server 200.

The communication interface 240 of the golf service server 200 may receive a swing area allocation request from the user terminal 500 or the administrator terminal 400, may transmit a swing area allocation response to the user terminal 500 or the administrator terminal 400, may transmit a swing area login request to the golf simulation device 100, may receive a swing area login response from the golf simulation device 100, and may transmit a swing area login completion notification to the user terminal 500 or the administrator terminal 400.

The controller 230 of the golf service server 200 may control the communication interface 240 to transmit the swing area login completion notification after receiving the swing area login response from the golf simulation device 100.

The swing area login completion notification transmitted by the communication interface 240 of the golf service server 200 may be information indicating that a login state has been automatically output according to the login initiation condition set in advance in the golf simulation device 100.

The communication interface 140 of the golf simulation device 100 may receive a swing area login request from the golf service server 200, and may transmit a swing area login response to the golf simulation device 100.

The controller 130 of the golf simulation device 100 may determine the time point at which a login state is output after receiving the swing area login request from the golf service server 200.

The output interface of the golf simulation device 100 may output the login state as visual information, auditory information, tactile information, or a combination thereof.

The swing area login response output by the output interface of the golf simulation device 100 may be information indicating that a login state has been automatically output according to the login initiation condition set in advance in the golf simulation device 100.

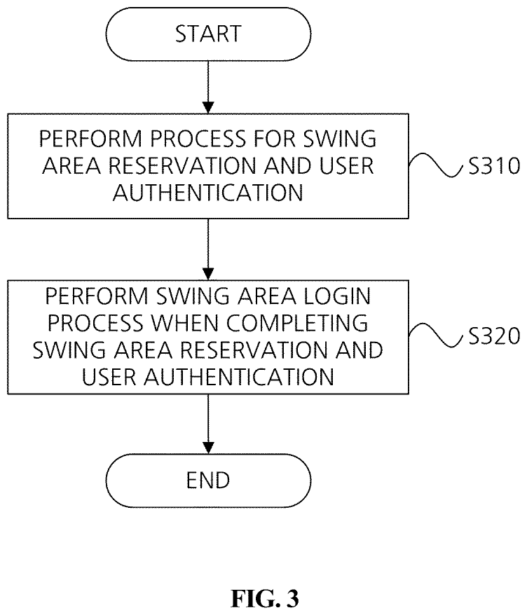

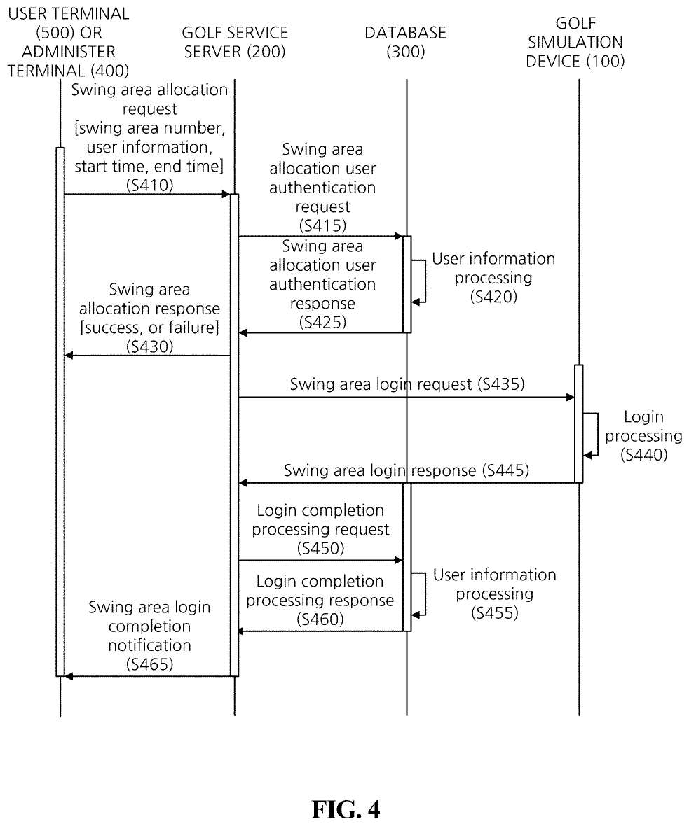

FIGS. 3 and 4 are flowcharts illustrating a golf swing area login method according to one embodiment.

The swing area login method includes steps that are processed in some or all of the golf simulation device 100, the golf service server 200, the database 300, the administrator terminal 400, and the user terminal 500.

Referring to FIG. 3, in step S310, the golf service server 200 performs a process for a swing area reservation and user authentication. In step S320, when the golf service server 200 completes the swing area reservation and the user authentication, the golf simulation device 100 performs a swing area login process.

Referring to FIG. 4, step S310 of performing a process for a swing area reservation and user authentication may include: step S410 of receiving, by the golf service server 200, a swing area allocation request from the user terminal 500 or the administrator terminal 400; step S415 of transmitting, by the golf service server 200, an authentication request for user information related to swing area allocation to the database 300 when the golf service server 200 receives the swing area allocation request; step S420 of searching, by the database 300, for the user information and then comparing and verifying, by the database 300, the user information; step S425 of receiving, by the golf service server 200, an authentication response for the user information from the database 300; and step S430 of transmitting, by the golf service server 200, a swing area allocation response to the user terminal 500 or the administrator terminal 400 when the golf service server 200 receives the authentication response for the user information.

The swing area allocation request transmitted from the user terminal 500 or the administrator terminal 400 to the golf service server 200 may include a swing area number, user information (e.g., a member number, contact information, a nickname, and/or the like), a start time, and an end time. For example, when user information is transmitted, i) the user information may be transmitted by transmitting app login information together with a swing area number, or ii) a swing area number may be transmitted together with a member number, contact information, and/or the like input by a user (or administrator). When the information required for login is transmitted, information for authentication and synchronization may be transmitted by transmitting the user information stored in an app using i) a method of capturing an image of the QR code, displayed via the simulation device 100 or administrator terminal 400, with the user terminal 500 (or an app installed on the user terminal), or ii) a method of inputting the number, displayed via the simulation device 100 or administrator terminal 400, to the user terminal 500 (or an app installed on the user terminal).

The database 300 may perform user authentication via step S420 of searching for user information and comparing and verifying the user information.

The golf service server 200 may transmit information indicating success or failure as a result of the swing area reservation and allocation.

Step S320 of performing the swing area login process may include: step S435 of transmitting, by the golf service server 200, a swing area login request to the golf simulation device 100; step S440 of processing a swing area login to synchronize user information with the content provided by the golf simulation device 100; and step S445 of receiving, by the golf service server 200, a swing area login response from the golf simulation device 100.

In step S320 of performing the swing area login process, swing area login may be automatically processed, and then a notification may be provided via a mobile/back office.

Step S320 of performing the swing area login process may include the step of transmitting, by the golf service server 100, a swing area login completion notification to the user terminal 500 or the administrator terminal 400 when the golf service server 200 receives the swing area login response from the golf simulation device 100.

Step S320 of performing the swing area login process may include: step S450 of transmitting, by the golf service server 200, a login completion processing request to the database 300 when the golf service server 200 receives a swing area login response from the golf simulation device 100; step S455 of searching, by the database 300, for the user information and then updating, by the database 300, information related to the user information; and step S460 of receiving, by the golf service server 200, a login completion processing response from the database 300.

Step S320 of performing the swing area login process may include, after step S455 of transmitting the swing area login response or step S465 of transmitting the swing area login completion notification, the step of collecting, by the golf simulation device 100, swing data in conjunction with the user information according to the swing area login by the golf simulation device 100 and transmitting, by the golf simulation device 100, the swing data to the golf service server 200, and analyzing, by the golf service server 200, the swing data and providing, by the golf service server 200, customized content. The golf swing area login method may include, after step S320 of performing the swing area login process, the step of collecting, by the golf simulation device, swing data in conjunction with the user information according to the swing area login by the golf simulation device and transmitting, by the golf simulation device, the swing data, and analyzing, by the golf service server, the swing data and providing, by the golf service server, customized content.

In the step of providing the customized content, appropriate content is matched and provided by identifying the basic physical conditions, such as gender, age, body type, muscle strength, and flexibility, of the golfer, accumulating and analyzing per-person data, such as joint changes attributable to the swing posture and body movements, and analyzing the golfer's shot information according to the swing, distance, trajectory, and driving quality.

Step S320 of performing the swing area login process may include, after step S455 of transmitting a swing area login response or step S465 of transmitting the swing area login completion notification, the step of providing, by the golf service server 200, a mission and a reward to the user terminal 400 in conjunction with the user information according to the swing area login by the golf simulation device 100. The golf swing area login method may include, after the step of performing the swing area login process, the step of providing, by the golf service server, a mission and a reward to the user terminal in conjunction with the user information according to the swing area login by the golf simulation device.

The content provided by the golf simulation device corresponds to personalized virtual golf course content, competitive virtual golf course content, mission-type virtual golf course content, customized golf education and training content, or a combination thereof.

Step S440 of processing the swing area login may include outputting the login state as visual information, auditory information, tactile information, or a combination thereof via the output interface of the golf simulation device 100.

Step S440 of processing the swing area login may include automatically outputting the login state when the preset login initiation condition is satisfied.

The login initiation condition may be set using a time-based method in which it is determined whether the current time corresponds to or exceeds the reservation start time, a distance-based method in which it is determined whether the user terminal 500 is located within a predetermined range of distances from the golf simulation device 100, or a communication-based synchronization method in which it is determined whether a specific message is transmitted to the golf simulation device 100 in response to the activation of an application installed on the user terminal 500. Accordingly, the login initiation condition may be determined to be satisfied when the current time corresponds to or exceeds the reservation start time, the login initiation condition may be determined to be satisfied when the user terminal 500 is located within the predetermined range of distances from the golf simulation device 100, or the login initiation condition may be determined to be satisfied when the specific message is transmitted to the golf simulation device 100 in response to the activation of the application installed on the user terminal 500.

Step S440 of processing the swing area login may include comparing and determining the login initiation condition when a preset login determination loop condition is satisfied. The reason for this is that the login initiation condition cannot be determined infinitely throughout the business hours of a shop.

The login determination loop condition may be set by considering the range from the reservation start time to the reservation end time. The range from the reservation start time to the reservation end time may be distinguished by a time slot. By applying detailed time slots, time reservations may be made in the form of stepping stones without filling up the continuous time when reserving a specific swing area.

For example, the login determination loop condition may be set as i) a condition for determining whether the current time is within the range from the reservation start time to the reservation end time according to the time slot in a situation where a user who made the reservation has not yet arrived, or ii) a condition for determining whether the reservation has not been canceled within the range from the reservation start time to the reservation end time. Accordingly, for example, the login determination loop condition may be determined to be satisfied when the current time is within the range from the reservation start time to the reservation end time according to the time slot in a situation where the user who made the reservation has not yet arrived, or the login determination loop condition may be determined to be satisfied when the reservation has not been canceled within the range from the reservation start time to the reservation end time.

When a user changes the swing area because the user who made a reservation has reached the swing area and then a specific situation occurs while the user swings in the swing area, or when a preferred swing area becomes empty in the middle of a time slot, the login determination loop condition may be applied again on a per-time slot basis in another golf simulation device or may be processed as being omitted on a per-time slot basis. Since the reward for login may vary depending on whether login is processed as being performed again in another golf simulation device or whether login is processed as being maintained, it is necessary to provide clear criteria for login processing. For example, the number of connections or the duration of connection may be applied as a reward weight.

Step S440 of processing the swing area login may include determining, by the golf simulation device 100 or golf service server 200, whether to change the swing area based on the location movement of the user terminal 500, the input information of the user terminal 500, the input information of the administrator terminal 400, or a combination thereof.

When it is determined by the golf simulation device 100 or golf service server 200 that the swing area is changed, the login state may be output to the output interface of the other golf simulation device 101.

When it is determined by the golf simulation device 100 or golf service server 200 that the swing area is not changed, the login state may be maintained.

When the swing area has been changed from the golf simulation device 100 to the other golf simulation device 101, the login state may be output to the output interface of the other golf simulation device 101, and the output of the login state from the golf simulation device 100 may be ended.

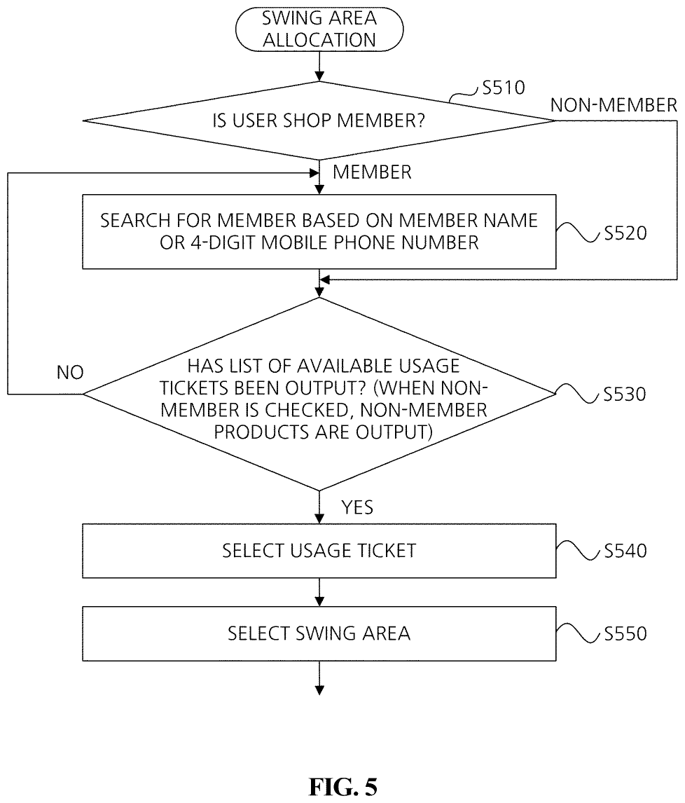

FIGS. 5 to 8 are flowcharts illustrating swing area allocation attempted using an administrator terminal in a golf swing area login method according to one embodiment.

Referring to FIG. 5, in step S510, the administrator terminal 400 determines whether a user is a shop member. For example, whether the user is a shop member may be checked via information such as a photo taken at the entrance of the shop or a fingerprint obtained at the entrance of the shop. In step S520, when the user is a member, member information is searched for by using a member name or a 4-digit mobile phone number. When the user is not a member, the member information search step is omitted.

In step S530, it is determined whether a list of available usage tickets is output. A usage ticket purchased, a usage ticket provided as a reward, and/or the like may be shown in the list of usage tickets. When it is checked that the user is a non-member, one or more non-member products may be output. When the list of usage tickets is not output, member information may be searched for again.

In step S540, a usage ticket is selected, and in step S550, a specific swing area is selected by inputting it. The administrator terminal 400 may receive a swing area list during the process of inputting a swing area. The administrator terminal 400 may select a swing area number displayed in the swing area list, or may directly input a swing area number.

After step S550, a different swing area allocation process may be performed depending on the type and version of an application installed in the administrator terminal 400.

When data is compared and determined in step S530, the determination may be made based on data stored in the golf simulation device 100, data stored in the golf service server 200, or data stored in the database 300.

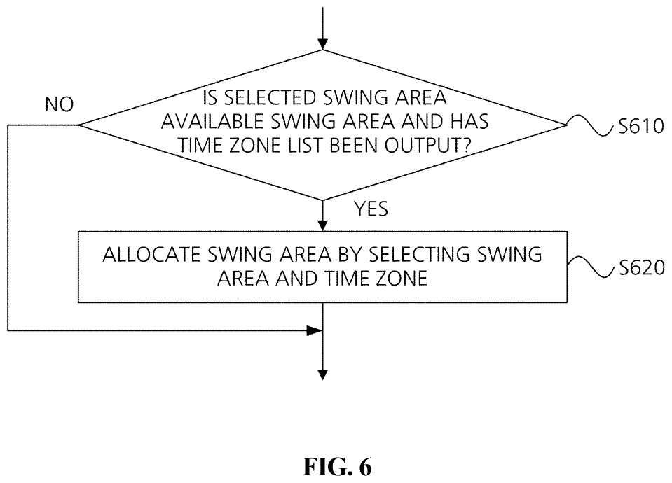

Referring to FIG. 6, after step S550, in step S610, it is determined whether the selected swing area is an available swing area and whether a time zone list is output. In step S610, whether the selected swing area is an available swing area and other available swing areas may be output. In step S620, a swing area and a time zone are selected, and the swing area is allocated.

When data is compared and determined in step S610, the determination may be made based on data stored in the golf simulation device 100, data stored in the golf service server 200, or data stored in the database 300.

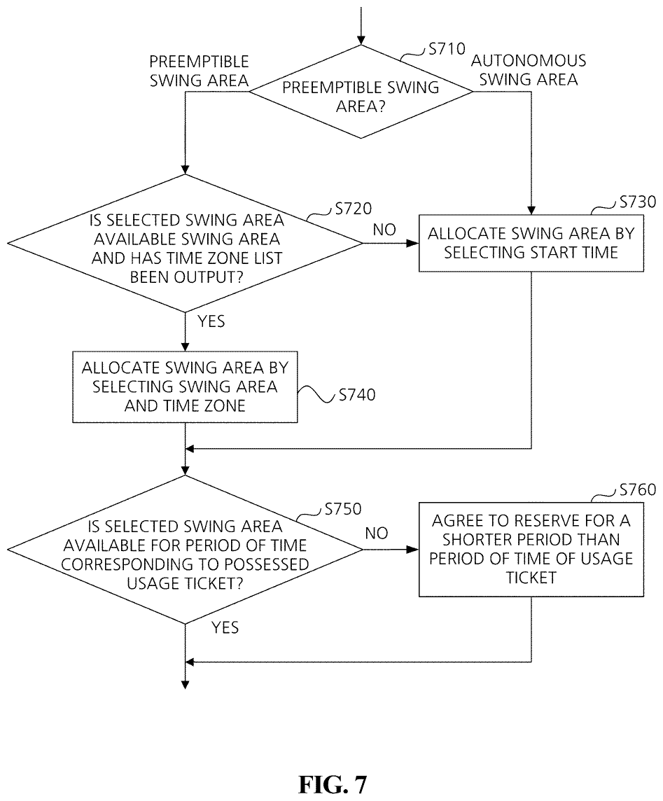

Referring to FIG. 7, after step S550, in step S710, it is determined whether the selected swing area is a preemptible swing area. When the location of the swing area can be preempted, it is a preemptible swing area. Otherwise, it is an autonomous swing area. When the selected swing area is a preemptible swing area, it is determined whether the selected swing area is an available swing area and whether a time zone list has been output in step S720. In step S720, other available swing areas may be output together with whether the selected swing area is an available swing area. When the selected swing area is an autonomous swing area, a start time is selected and a swing area is allocated in step S730. When the selected swing area is not an available swing area or when other available swing areas and a time zone list have not been output in step S720, step S730 is performed. In other words, it may be changed to an autonomous swing area and then processed. When the selected swing area corresponds to an available swing area and a time zone list has been output, or other available swing areas and a time zone list have been output in step S720, a swing area and a time zone are selected and the swing area is allocated in step S740.

In step S750, it is determined whether the selected swing area is available for a period of time corresponding to a possessed usage ticket. When there is sufficient time, the process proceeds to a subsequent step. When there is no sufficient time, the process proceeds to a subsequent step by agreeing to reserve for a shorter time than the period of time corresponding to the usage ticket in step S760.

When data is compared and determined in steps S720 and S750, the determination may be made based on data stored in the golf simulation device 100, data stored in the golf service server 200, or data stored in the database 300.

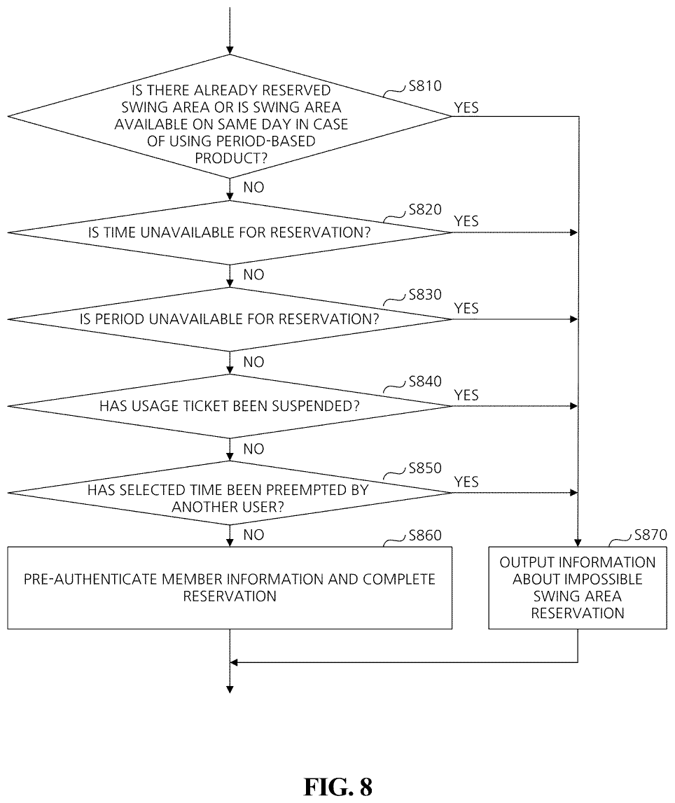

Referring to FIG. 8, after step S620, S750, or S760, in step S810, whether there is already a reserved swing area or whether a swing area is available on the same day in the case of using a period-based product is determined. A limitation in which a swing area can only be used once a day may be set for such a period-based product. When there is already a reserved swing area or a swing area has been used on the same day in the case of using a period-based product, the information that the swing area cannot be reserved is output in step S870.

When there is no reserved swing area and a swing area has not been used on the same day in the case of using a period-based product in step S810, it is determined whether the time in question is unavailable for reservation in step S820. When the time is unavailable for reservation in step S820, step S870 is performed.

When the time is not unavailable for reservation in step S820, it is determined whether a period in question is unavailable for reservation in step S830. When the period is unavailable for reservation in step S830, it is determined whether the usage ticket is suspended in step S840. When the usage ticket is suspended in step S840, step S870 is performed.

When the period is not unavailable for reservation in step S830, it is determined whether the usage ticket is suspended in step S840. When the usage ticket is suspended in step S840, step S870 is performed. When the usage ticket is not suspended in step S840, it is determined whether the selected time has been preempted by another user in step S850. When the selected time has been preempted by another user at step S850, step S870 is performed.

When the selected time is not preempted by another user in step S850, the member information is pre-authenticated and the reservation is completed in step S860.

When data is compared and determined in steps S810, S820, S830, S840, and S850, the determination may be made based on data stored in the golf simulation device 100, data stored in the golf service server 200, or data stored in the database 300.

In connection with the usage ticket, when the reserved time information and the time information included in the usage ticket possessed by a user are compared and the time information included in the usage ticket possessed by the user is shorter than the reserved time information (for example, when the remaining time included in the usage ticket possessed by the user is one hour and the time reserved by the user for the swing area is two hours), there may be applied the step of allowing the user to complete the reservation by issuing a ‘conditional post-payment coupon’ for a reservation process and combining the ‘conditional post-payment coupon’ issued with the usage ticket possessed by the user.

In this case, the ‘conditional post-payment coupon’ may include information about the insufficient time required to proceed with the reservation, and the information about the insufficient time may be calculated based on the “remaining time information of the usage ticket and the reservation time information.”

Meanwhile, in connection with the ‘conditional post-payment coupon,’ whether to pay the issuance fee may be determined after the user has completed using the content provided by the golf simulation device based on whether a preset condition is satisfied. For example, when the total number of strokes in a practice round using the content provided by the golf simulation device is smaller than the preset number of strokes, the coupon issuance fee is not required (the coupon is provided free of charge). In contrast, when the total number of strokes in a practice round using the content provided by the golf simulation device exceeds the preset number of strokes, the user may be required to pay the coupon issuance fee when leaving a golf range. In this case, the coupon issuance fee may be a fee calculated based on time when an hourly membership is purchased, or may be a fee obtained by adding an additional fee to a fee calculated based on time.

In addition, in the case of a hole-in-one in a practice round using the content provided by the golf simulation device, a coupon may be provided free of charge regardless of the total number of strokes, so that no coupon issuance fee may be charged.

From the perspective of the screen golf system, it has the effect of preventing members from leaving by encouraging users to use the system, and from the perspective of the users, it has the effect of promoting skill improvement by allowing them to focus more on the game.

The administrator terminal 400, the user terminal 500, or the golf service server 200 associates the time insufficiency of the usage ticket (a situation where it is difficult to use the usage ticket for the desired reservation time) with the user information. When the time of the user's usage ticket is insufficient as a result of checking the available time of the selected swing area, the time insufficiency situation, the inquiry date and time, and the swing area information are associated with the user information and stored in the golf service server 200 or database 300. When it is determined that the time insufficiency situation information based on the usage ticket is associated with the user information during a swing area login process, the golf service server 200 or golf simulation device 100 may provide mission content after the swing area login and provide an additional usage ticket as a reward based on acceptance and mission accomplishment. For example, the reservation for the desired time may not be made due to the time insufficiency of the usage ticket in the swing area reservation process, but the user may extend the reservation time or make a subsequent reservation by using the usage ticket provided as a reward by performing the mission provided to the user after the swing area login.

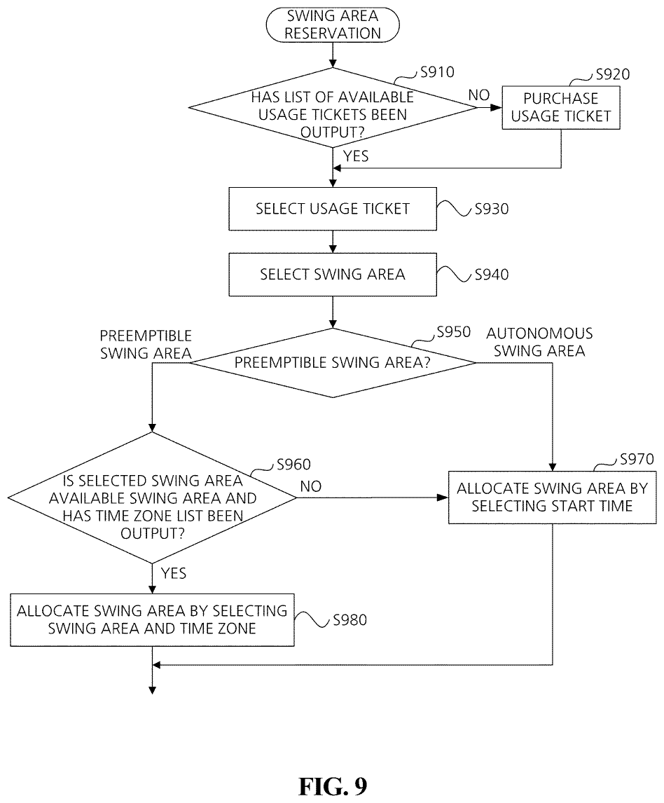

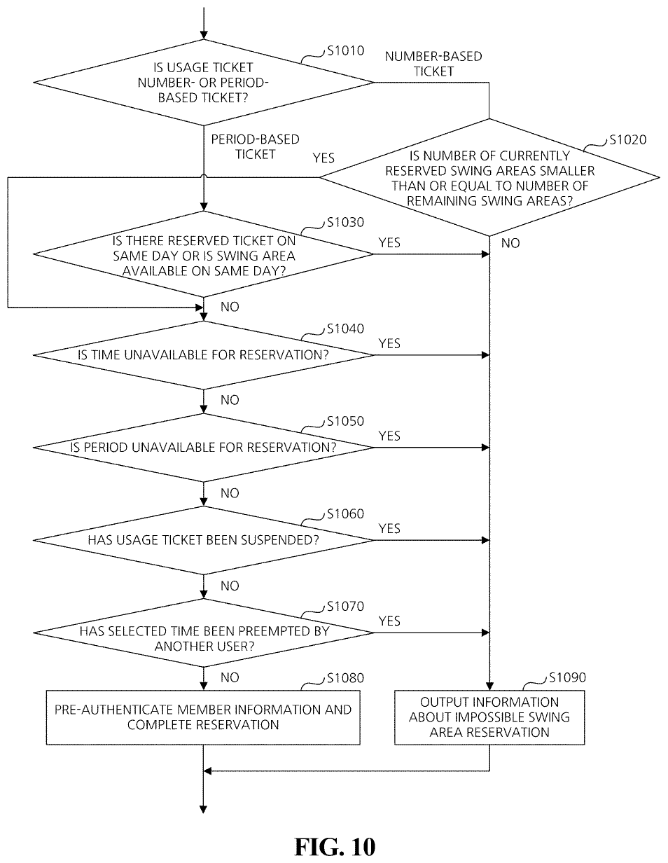

FIGS. 9 and 10 are flowcharts illustrating a swing area reservation attempted using a user terminal in a golf swing area login method according to one embodiment.

Referring to FIG. 9, in step S910, the user terminal 500 determines whether a list of available usage tickets is output. When the list of available usage tickets is not output, a usage ticket may be purchased in step S920.

In step S930, a usage ticket is selected, and in step S940, a specific swing area is input and selected. The user terminal 500 may be provided with a swing area list in the process of inputting a swing area. The user terminal 500 may select a swing area number shown in the swing area list, or may directly input a swing area number.

In step S950, it is determined whether the selected swing area is a preemptible swing area. When the location of the swing area can be preempted, it is a preemptible swing area. Otherwise it is an autonomous swing area. When the selected swing area is a preemptible swing area, it is determined whether the selected swing area is an available swing area and whether a time zone list has been output. In step S960, whether the selected swing area corresponds to an available swing area and other available swing areas may be output. When the selected swing area is an autonomous swing area, a start time is selected and a swing area is allocated in step S970. When the selected swing area does not correspond to an available swing area or other available swing areas and a time zone list have not been output in step S960, step S970 is performed. When the selected swing area corresponds to an available swing area and a time zone list has been output or other available swing areas and a time zone list have been output in step S960, a swing area and a time zone are selected and the swing area is allocated in step S980.

When data is compared and determined in steps S910, S950, and S960, the determination may be made based on data stored in the golf simulation device 100, data stored in the golf service server 200, or data stored in the database 300.

Referring to FIG. 10, after step S970 or step S980, in step S1010, it is determined whether the usage ticket corresponds to a number-based ticket or a period-based ticket. When the usage ticket corresponds to a number-based ticket, it is determined whether the number of currently reserved swing areas is smaller than or equal to the number of remaining swing areas in step S1020. When the number of currently reserved swing areas is smaller than or equal to the number of remaining swing areas, step S1040 is performed. When the number of currently reserved swing areas is larger than the number of remaining swing areas, the information that the swing area reservation is not possible is output in step S1090.

When the usage ticket corresponds to a period-based ticket in step S1010, it is determined whether there is a reserved swing area on the same day or whether a swing area can be used on the same day in step S1030. A limitation in which a swing area can only be used once a day may be set for the period-based ticket. When there is already a reserved swing area on the same day or a swing area has been used on the same day, step S1090 is performed.

When the number of currently reserved swing areas is smaller than the number of remaining swing areas in step S1020 or when there is no reserved swing area on the same day and a swing areas has not be used in S1030, it is determined whether the time in question is unavailable for reservation in step S1040. When the time is unavailable for reservation in step S1040, step S1090 is performed.

When the time is not unavailable for reservation in step S1040, it is determined whether a period in question is unavailable for reservation in step S1050. When the period is unavailable for reservation in step S1050, step S1090 is performed.

When the period is not unavailable for reservation in step S1050, it is determined whether the usage ticket is suspended in step S1060. When the usage ticket is not suspended in step S1060, step S1090 is performed.

When the usage ticket is not suspended in step S1060, it is determined whether a selected time is preempted by another user in step S1070. When the selected time is preempted by the other user in step S1070, step S1090 is performed.

When the selected time is not preempted by the other user in step S1070, the member information is pre-authenticated and the reservation is completed in step S1080.

When data is compared and determined in steps S1010, S1020, S1030, S1040, S1050, S1060, and S1070, the determination may be made based on data stored in the golf simulation device 100, data stored in the golf service server 200, or data stored in the database 300.

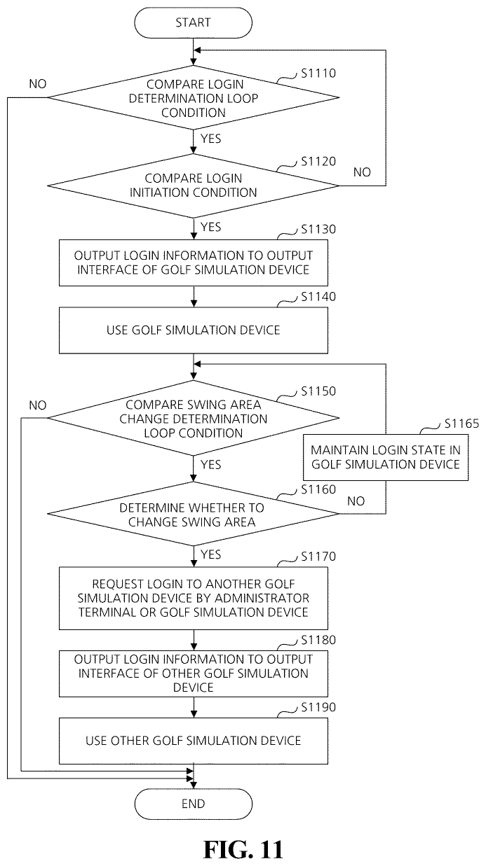

FIG. 11 is a flowchart illustrating automatic login using a golf simulation device in a golf swing area login method according to one embodiment.

Referring to FIG. 11, after step S860, step S870, step S1080, or step S1090, a login determination loop condition is compared in step S1110. When the login determination loop condition is not satisfied in step S1110, the login process is ended.

When a login determination loop condition is satisfied in step S1110, a login initiation condition is compared in step S1120. When the login initiation condition is not satisfied in step S1120, step S1110 is performed again. When the login initiation condition is satisfied in step S1120, login information is output to the output interface of the golf simulation device 100 in step S1130. The output of the login information may appear in the form of, for example, a login pop-up. When the login pop-up is ‘confirmed’ or a predetermined time (e.g., 3 minutes, etc.) has elapsed after the login pop-up, the golf simulation device 100 becomes available.

In step S1140, the golf simulation device 100 may provide golf content, and a golfer may use the golf simulation device 100. The golfer may select personalized virtual golf course content, competitive virtual golf course content, mission-type virtual golf course content, customized golf education and training content, or a combination thereof that is provided by the golf simulation device 100. According to the selected golf content, the golfer may swing in the swing area.

There are cases where one golf simulation device 100 is used during the reservation time, and there may be cases where the golf simulation device is changed to another golf simulation device depending on the situation.

In step S1150, the golf simulation device 100 compares a preset swing area change determination loop condition. The swing area change determination loop condition may be used to prepare for the case where the change of the swing area is infinitely determined.

The swing area change determination loop condition may be set by considering the remaining reservation time range. The remaining reservation time range may have the range of the time, obtained by excluding the time used from the total reservation time, up to the reservation end time, and may be divided into time slots.

For example, the swing area change determination loop condition may be set as i) a condition for determining whether the current time is within the remaining reservation time range according to the time slot in a situation where the user is using one golf simulation device, and ii) a condition for determining whether the user has temporarily suspended the use of one golf simulation device within the remaining reservation time range. Accordingly, for example, the swing area change determination loop condition may be determined to be satisfied when the current time is within the remaining reservation time range according to the time slot in a situation where the user is using one golf simulation device 100, or the swing area change determination loop condition may be determined to be satisfied when the user has temporarily suspended the use of one golf simulation device within the remaining reservation time range.

When the swing area change determination loop condition is not satisfied in step S1150, the swing area login process is ended.

When the swing area change determination loop condition is satisfied in step S1150, it is determined whether the swing area is changed in S1160. When it is determined that the swing area is changed in step S1160, a login state is maintained in the golf simulation device 100 in step S1165.

When it is determined that the swing area is changed in step S1160, a login request is made to another golf simulation device by the administrator terminal 400 or golf simulation device 100 in step S1170. In step S1170, the golf simulation device 100 suspends the content, remembers the point where the content is suspended, and shares it with the administrator terminal 400, the golf service server 200, the database 300, or the other golf simulation device.

In step S1180, login information is output to the output terminal of the other golf simulation device. When a login pop-up is confirmed by selecting ‘Confirm’ or a predetermined time (e.g., three minutes) has elapsed, the other golf simulation device becomes available.

After step S1180 of outputting login information to the output interface of the other golf simulation device, in step S1190, the golf simulation device 100 may provide golf content, and the golfer may use the golf simulation device 100.

In step S1190, the golfer may start golf content anew or continue from the point where the golf content was suspended via the other golf simulation device. The other golf simulation device may receive information about the point where the golf content was suspended from the golf simulation device 100, the administrator terminal 400, the golf service server 200, or the database 300.

When data is compared and determined in steps S1110, S1120, S1150, and S1160, the determination may be made based on data stored in the golf simulation device 100, data stored in the golf service server 200, or data stored in the database 300.

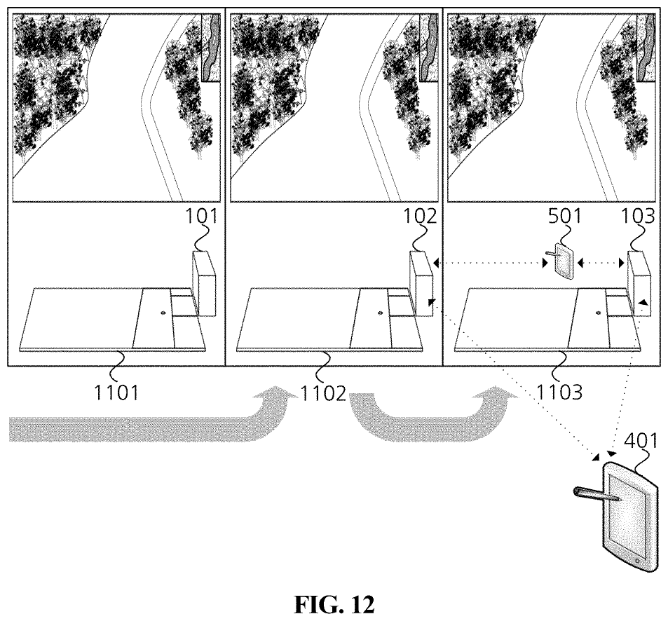

FIG. 12 is a view illustrating a swing area change situation in a golf swing area login method according to one embodiment.

Assuming that there are a first swing area 1101 provided in a first golf simulation device 101, a second swing area 1102 provided in a second golf simulation device 102, and a third swing area 1103 provided in a third golf simulation device 103, a user may practice a golf swing in the second swing area 1102. When there occurs a situation where a user wants to change the swing area to the third swing area 1103 during practice, it is possible to determine whether to change the swing area based on the location movement of the user terminal 501, the input information of the user terminal 501, the input information of the administrator terminal 401, or a combination thereof.

There may be set a command-based method in which a user terminal 501 transmits a message requesting the change of the swing area to an administrator terminal 401 and second golf simulation device 102 or the administrator terminal 401 or second golf simulation device 102 transmits a control command to the third golf simulation device 103 or golf service server 200 after receiving the user request, a location-based method in which the user terminal 501 transmits a message requesting the change of the swing area to the administrator terminal 401 or second golf simulation device 102 and then determines whether to move based on the distance from the second golf simulation device 102 and the distance from the third golf simulation device 103, or a communication-based synchronization method in which, when the user terminal 501 transmits a message requesting the change of the swing area to the second golf simulation device 102 or third golf simulation device 103, the second golf simulation device 102 and the third golf simulation device 103 process the change of the swing area while communicating with each other.

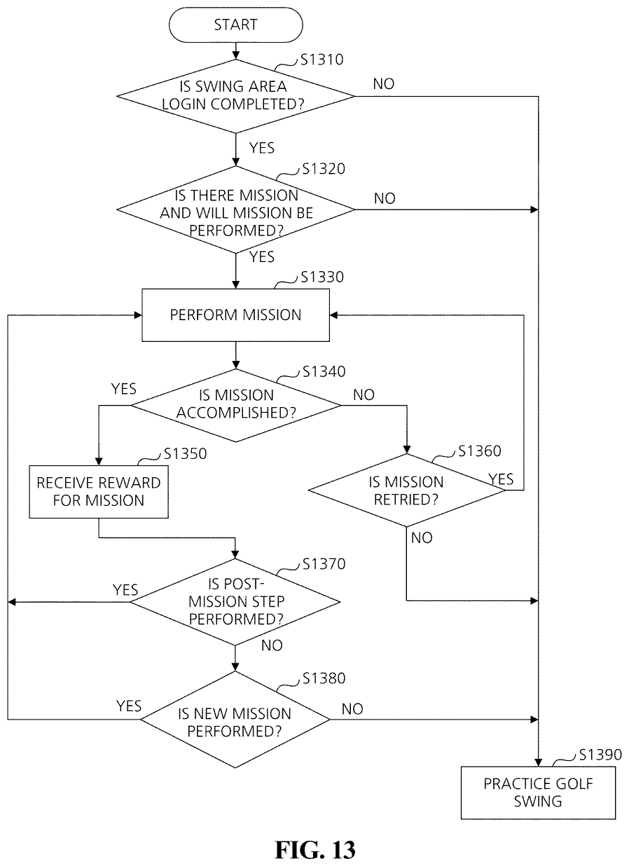

FIG. 13 is a flowchart illustrating the provision of a mission and a reward after login in a golf swing area login method according to one embodiment.

Referring to FIG. 13, after step S320 or step S1130, in step S1310, the golf simulation device 100 or golf service server 200 determines whether a swing area login is completed. When the swing area login is not completed in step S1310, practice content is provided without providing a reward for the login in step S1390.

When the swing area login is completed in step S1310, the golf simulation device 100 or the golf service server 200 may provide a reward for the login.

When a reward is provided, it may be provided as digital content that can be used in-game, such as a usage ticket, a practice range theme, a ball tail (a visual effect that temporarily appears on a ball's trajectory when the ball flies), an item that can stimulate the desire to collect and show off, such as a mission accomplishment badge, or a real prize gift exchange ticket that is through a partnership with a golf equipment company or the like. The usage ticket received as a reward may be used to reserve a swing area.

In step S1320, the golf simulation device 100 or the golf service server 200 performs a mission.

In step S1340, it is determine whether the mission has been accomplished. When the mission has been accomplished in step S1340, a reward for the mission is provided in step S1350. When the mission has not been accomplished in step S1340, whether to retry the mission is determined in step S1360. When it is determined that the mission is retried in step S1360, step S1330 is performed. When it is determined that the mission is not retried in step S1360, step S1390 is performed.

In step S1370, whether to perform a post-mission step is determined. When it is determined that the post-mission step is performed in step S1370, step S1330 is performed. When it is determined that the post-mission step is not performed in step S1370, whether to perform a new mission is determined in step S1380. When it is determined that a new mission is performed in step S1380, step S1330 is performed. When it is determined that a new mission is not performed in step S1380, step S1390 is performed.

The golf swing area login method according to the embodiments shown in FIGS. 3 to 13 includes the steps that are processed in a time-series manner by the golf swing area login system shown in FIGS. 1 and 2. Accordingly, the partial descriptions that are omitted but have been given in conjunction with the golf swing area login system may be applied to the golf swing area login method, and the partial descriptions that are omitted but have been given in conjunction with the golf swing area login method may be applied to the golf swing area login system.

The term “unit” used in the above-described embodiments means software or a hardware component such as a field-programmable gate array (FPGA) or application-specific integrated circuit (A SIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

Components and a function provided in “unit(s)” may be coupled to a smaller number of components and “unit(s)” or divided into a larger number of components and “unit(s).”

In addition, components and “unit(s)” may be implemented to run one or more central processing units (CPUs) in a device or secure multimedia card.

The golf swing area login method according to one embodiment described herein may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, the golf swing area login method according to one embodiment described herein may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, the golf swing area login method according to one embodiment described herein may be implemented in such a manner that the above-described computer program is executed by a computing device. The computing device may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing device. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.
10: screen golf system 11: swing mat
12: sensing device 13: screen
14: image output device 100: golf simulation device
200: golf service server 300: database
400: administrator terminal 500: user terminal

1. A golf swing area login method comprising:
performing, by a golf service server, a process for a swing area reservation and user authentication; and
performing, by a golf simulation device, a swing area login process when the golf service server completes the swing area reservation and the user authentication.

2. The golf swing area login method of claim 1, wherein performing the process for a swing area reservation and user authentication comprises:
receiving, by the golf service server, a swing area allocation request from a user terminal or an administrator terminal;
transmitting, by the golf service server, an authentication request for user information related to swing area allocation to a database when the golf service server receives the swing area allocation request;
searching, by the database, for the user information and then comparing and verifying, by the database, the user information;
receiving, by the golf service server, an authentication response for the user information from the database; and
transmitting, by the golf service server, a swing area allocation response to the user terminal or the administrator terminal when the golf service server receives the authentication response for the user information.

3. The golf swing area login method of claim 1, wherein performing the process for a swing area reservation and user authentication comprises:
determining whether a selected swing area corresponds to a preemptible swing area or an autonomous swing area, and determining whether the selected swing area is an available swing area and whether a time zone list has been output when the selected swing area corresponds to the preemptible swing area; and
selecting and allocating a swing area and a time zone when the selected swing area corresponds to the available swing area and the time zone list has been output or when other available swing areas and the time zone list have been output.

4. The golf swing area login method of claim 1, wherein performing the process for a swing area reservation and user authentication comprises:
determining whether a selected swing area corresponds to a preemptible swing area or an autonomous swing area, and selecting a start time and also allocating a swing area when the selected swing area corresponds to the autonomous swing area.

5. The golf swing area login method of claim 1, wherein performing the process for a swing area reservation and user authentication comprises:
determining whether a selected swing area is an available swing area and whether a time zone list has been output when the selected swing area corresponds to a preemptible swing area; and
changing the selected swing area to an autonomous swing area and then allocating it when the selected swing area does not correspond to the available swing area or when other available swing areas and the time zone list have not been output.

6. The golf swing area login method of claim 1, wherein performing the process for a swing area reservation and user authentication comprises:
determining whether a selected swing area is available for a period of time of a possessed usage ticket; and
agreeing to reserve the swing area for a shorter period of time than that of the possessed usage ticket when the former period of time is not sufficient.

7. The golf swing area login method of claim 1, wherein performing the swing area login process comprises:
transmitting, by the golf service server, a swing area login request to the golf simulation device;
processing a swing area login to synchronize user information with the content provided by the golf simulation device; and
receiving, by the golf service server, a swing area login response from the golf simulation device.

8. The golf swing area login method of claim 7, wherein performing the swing area login process comprises:
transmitting, by the golf service server, a swing area login completion notification to the user terminal or the administrator terminal when the golf service server receives the swing area login response from the golf simulation device.

9. The golf swing area login method of claim 7, wherein performing the swing area login process comprises:
transmitting, by the golf service server, a login completion processing request to a database when the golf service server receives a swing area login response from the golf simulation device;
searching, by the database, for the user information and updating, by the database, information related to the user information; and
receiving, by the golf service server, a login completion processing response from the database.

10. The golf swing area login method of claim 7, comprising, after performing the swing area login process:
collecting, by the golf simulation device, swing data in conjunction with the user information according to the swing area login by the golf simulation device and transmitting, by the golf simulation device, the swing data, and analyzing, by the golf service server, the swing data and providing, by the golf service server, customized content.

11. The golf swing area login method of claim 7, comprising, after performing the swing area login process:
providing, by the golf service server, a mission and a reward to the user terminal in conjunction with the user information according to the swing area login by the golf simulation device.

12. The golf swing area login method of claim 11, wherein:
providing the mission and the reward comprises providing a usage ticket as the reward; and
in performing the process for a swing area reservation and user authentication, the swing area reservation is performed using the usage ticket.

13. The golf swing area login method of claim 7, wherein the content provided by the golf simulation device corresponds to personalized virtual golf course content, competitive virtual golf course content, mission-type virtual golf course content, customized golf education and training content, or a combination thereof.

14. The golf swing area login method of claim 7, wherein processing the swing area login comprises:
outputting a state of the swing area login as visual information, auditory information, tactile information, or a combination thereof via an output interface of the golf simulation device.

15. The golf swing area login method of claim 7, wherein processing the swing area login comprises:
automatically outputting a state of the swing area login when a preset login initiation condition is satisfied.

16. The golf swing area login method of claim 7, wherein processing the swing area login comprises:
comparing and determining a login initiation condition when a preset login determination loop condition is satisfied.

17. The golf swing area login method of claim 7, wherein processing the swing area login comprises:
determining, by the golf simulation device or the golf service server, whether to change the swing area based on location movement of a user terminal, input information of the user terminal, input information of an administrator terminal, or a combination thereof; and
outputting a state of the swing area login to an output interface of another golf simulation device when it is determined by the golf simulation device or the golf service server that the swing area is changed.

18. The golf swing area login method of claim 17, wherein:
the state of the swing area login is maintained when it is determined by the golf simulation device or the golf service server that the swing area is not changed; and
when the swing area has been changed from the golf simulation device to the other golf simulation device, the state of the swing area login is output to the output interface of the other golf simulation device, and the output of the state of the swing area login from the golf simulation device is ended.

19. A golf service server comprising:
a communication interface configured to receive a swing area allocation request from a user terminal or an administrator terminal, to transmit a swing area allocation response to the user terminal or the administrator terminal, to transmit a swing area login request to a golf simulation device, to receive a swing area login response from the golf simulation device, and to transmit a swing area login completion notification to the user terminal or the administrator terminal; and
a controller configured to control the communication interface to transmit the swing area login completion notification after receiving the swing area login response from the golf simulation device,
wherein the swing area login completion notification is information indicating that a state of a login has been automatically output according to a login initiation condition set in advance in the golf simulation device.

20. A golf simulation device comprising:
a communication interface configured to receive a swing area login request from a golf service server, and to transmit a swing area login response to the golf simulation device;
an output interface configured to output a state of a login as visual information, auditory information, tactile information, or a combination thereof; and
a controller configured to determine a time point at which the state of the login is output after receiving the swing area login request from the golf service server,
wherein the swing area login response is information indicating that the state of the login has been automatically output according to a login initiation condition set in advance in the golf simulation device.
